(19) United States
(12) Patent Application Publication
(10) Pub. No.: US 2016/0011714 A1
(43) Pub. Date: Jan. 14, 2016

(54) MOBILE DEVICE, CONTROL METHOD, AND COMPUTER PROGRAM PRODUCT

(71) Applicant: KYOCERA Corporation, Kyoto-shi (JP)

(72) Inventors: Junichi HASEGAWA, Tokyo-to (JP); Hidenori WATANABE, Yokohama-shi (JP); Hideko MURAKAMI, Yokohama-shi (JP)

(21) Appl. No.: 14/853,176

(22) Filed: Sep. 14, 2015

Related U.S. Application Data
(63) Continuation-in-part of application No. PCT/JP2014/056554, filed on Mar. 12, 2014.

(30) Foreign Application Priority Data
Mar. 15, 2013 (JP) 2013-053813

(51) Int. Cl. G06F 3/041

(52) U.S. Cl. CPC G06F 3/0416; G06F 2203/04104

(57) ABSTRACT

A mobile device includes a touch screen display including an acceptance area to accept a touch; and a controller configured to control function of the mobile device on the basis of the touch. When the touch includes at least one first touch at periphery of the acceptance area, the controller is configured to suspend function of the mobile device corresponding to the at least one first touch.

### CROSS-REFERENCE TO RELATED APPLICATIONS

This application is a Continuation-in-part of PCT international application Ser. No. PCT/JP2014/056554 filed on Mar. 12, 2014 which designates the United States, incorporated herein by reference, and which is based upon and claims the benefit of priority from Japanese Patent Applications No. 2013-053813 filed on Mar. 15, 2013, the entire contents of which are incorporated herein by reference.

### 1. FIELD

Some embodiments of the present disclosure relates to a mobile device, a control method, and a control program.

### 2. BACKGROUND

A device with a touch screen display has been known. Examples of the device with a touch screen display include, but are not limited to, a smartphone and a tablet. The device with a touch screen display detects a gesture of a finger or a stylus pen through the touch screen display. Then, the device with the touch screen display operates according to the detected gesture.

The basic operation of the device with the touch screen display is implemented by an OS (Operating System) built into the device such as Android (registered trademark), BlackBerry (registered trademark) OS, iOS, Symbian (registered trademark) OS, Windows (registered trademark) Phone, Firefox (registered trademark), and Tizen (registered trademark).

### SUMMARY

According to a first aspect, a mobile device is provided. The mobile device includes a touch screen display including an acceptance area to accept a touch; and a controller configured to control function of the mobile device on the basis of the touch, wherein when the touch includes at least one first touch at periphery of the acceptance area, the controller is configured to suspend function of the mobile device corresponding to the at least one first touch.

According to a second aspect, a method of controlling a mobile device, which includes: a touch screen display including an acceptance area to accept a touch; and a controller configured to control function of the mobile device on the basis of the touch, is provided. The method includes the steps of: accepting the touch in the acceptance area; and suspending, by the controller, functions of the mobile device corresponding to at least one first touch, if the touch includes the at least one first touch at periphery of the acceptance area.

According to a second aspect, a computer program product having computer instructions, stored on a non-transitory computer readable storage medium, for enabling a computer of a mobile device, which includes: a touch screen display including an acceptance area to accept a touch; and a controller configured to control function of the mobile device on the basis of the touch, executing the computer instructions to perform operations is provided. The operations include: accepting the touch in the acceptance area; and suspending function of the mobile device corresponding to at least one first touch, if the touch includes the at least one first touch at periphery of the acceptance area.

### BRIEF DESCRIPTION OF THE DRAWINGS

The above and other objects, features, advantages and technical and industrial significance of the present disclosure will be revealed by reading the following description with reference to the accompanying drawings. It should be noted that the drawings are provided only as being illustrative and are not intended to limit the scope of the present disclosure.

FIG. 1 is a perspective view of an appearance of a smartphone according to some embodiment,

FIG. 2 is a front view of an appearance of a smartphone according to some embodiment,

FIG. 3 is a back view of an appearance of a smartphone according to some embodiment,

FIG. 4 is a diagram of some example of a home screen,

FIG. 5 is a block diagram of a function of the smartphone according to some embodiment,

FIG. 6 is a diagram of an example of a control flow performed by a smartphone according to some embodiment, and

FIG. 7 is a diagram of another example of a control flow performed by a smartphone according to some embodiment.

### DETAILED DESCRIPTION OF EMBODIMENTS

Exemplary embodiments for implementing the present disclosure will be explained in detail with reference to the accompanying drawings. A smartphone will be explained below as some example of the mobile device with a touch screen display.

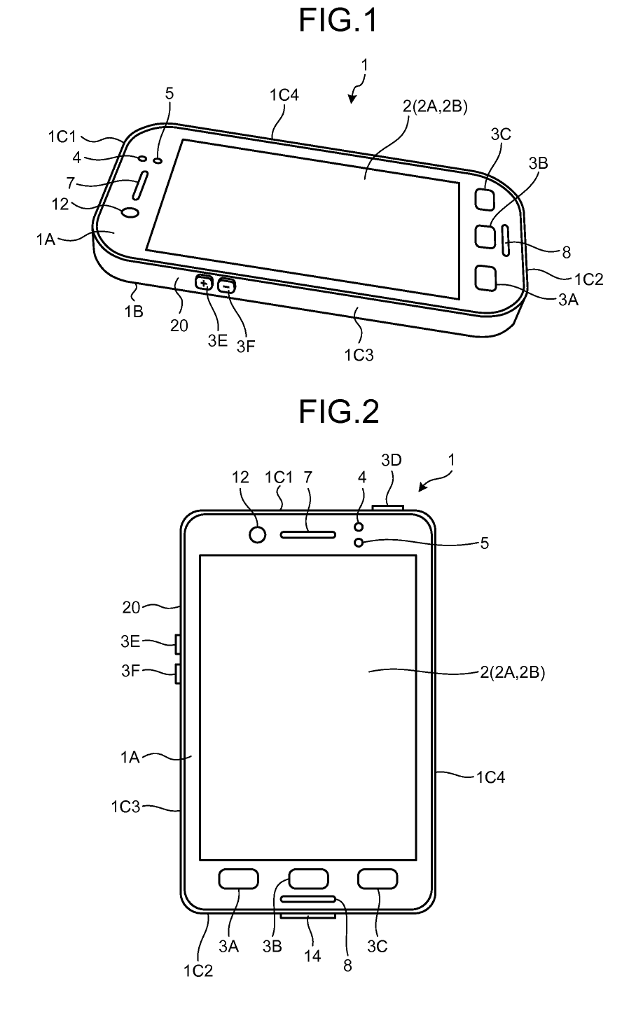

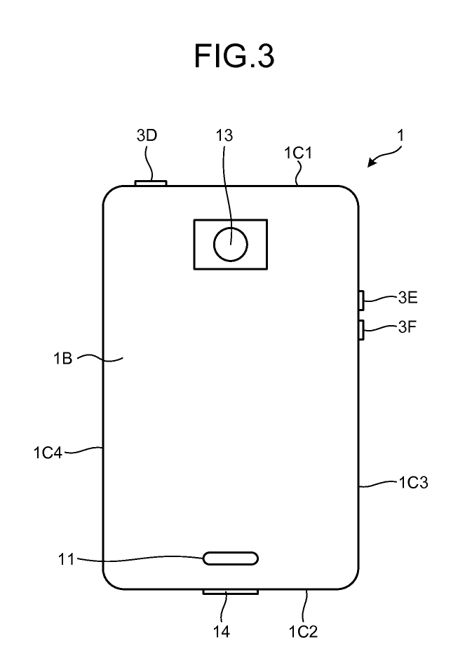

An appearance of a smartphone 1 according to some embodiment will be explained with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 has a touch screen display 2, buttons 3A to 3C, an illumination sensor 4, a proximity sensor 5, a receiver 7, a microphone 8, and a camera 12, which are provided in the front face 1A. The smartphone 1 has a camera 13 provided in the back face 1B. The smartphone 1 has buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. The display 2A includes a display device such as an LCD (Liquid Crystal Display), an OEL panel (Organic Electro-Luminescence panel), an IEL panel (Inorganic Electro-Luminescence panel) and like. The display 2A can display text, images, symbols, graphics, or the like.

The touch screen 2B can detect a contact of a finger, a stylus pen, or the like on the touch screen 2B. The touch screen 2B can detect positions where a plurality of fingers, stylus pens, or the like make contact with the touch screen 2B.

The detection method of the touch screen 2B may be any detection method of a capacitive type detection method, a resistive type detection method, a surface acoustic wave type (or ultrasonic type) detection method, an infrared type detection method, an electromagnetic induction type detection method, and a load sensing type detection method. In the capacitive type detection method, a contact or proximity of a finger, a stylus pen, or so can be detected. Hereinafter, for the sake of simple description, the finger, the stylus pen, or so of which contact is detected by the touch screen 2B may be simply called “finger”.

The smartphone 1 can determine a type of a gesture based on a contact detected by the touch screen 2B, a position where the contact is made, a periodical time during the contact is made, and a temporal change of the position where the contact is made. The gesture is an operation performed on the touch screen display 2. Examples of the gesture determined by the smartphone 1 include at least one of touch, long touch, release, swipe, tap, double tap, long tap, drag, flick, pinch in, pinch out, and like.

“Touch” is a gesture in which a finger makes contact with the touch screen 2B. The smartphone 1 may determine a gesture in which the finger makes contact with the touch screen 2B as touch. “Long touch” is a gesture in which a finger makes contact with the touch screen 2B for longer than a given time. The smartphone 1 may determine a gesture in which the finger makes contact with the touch screen 2B for longer than a given time as long touch. “Release” is a gesture in which a finger separates from the touch screen 2B. The smartphone 1 may determine a gesture in which the finger separates from the touch screen 2B as release. “Tap” is a gesture in which a touch is followed by a release. The smartphone 1 may determine a gesture in which a touch is followed by a release as tap. “Double tap” is a gesture such that a gesture in which a touch is followed by a release is successively performed twice. The smartphone 1 may determine a gesture such that a gesture in which a touch is followed by a release is successively performed twice as double tap. “Long tap” is a gesture in which a long touch is followed by a release. The smartphone 1 may determine a gesture in which a long touch is followed by a release as long tap.

“Swipe” is a gesture in which a finger moves on the touch screen display 2 with continuous contact thereon. The smartphone 1 may determine a gesture in which the finger moves on the touch screen 2B with continuous contact thereon as swipe. “Drag” is a gesture in which a swipe is performed from an area where a movable-object is displayed. The smartphone 1 may determine a gesture in which a swipe is performed from an area where the movable-object is displayed as drag.

“Flick” is a gesture in which a finger is released after a touch while moving at high speed along one direction. The smartphone 1 may determine a gesture in which the finger is released after a touch while moving at high speed along one direction as flick. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like.

“Pinch in” is a gesture in which a swipe with a plurality of fingers is performed in a direction to move the fingers toward each other. The smartphone 1 may determine a gesture in which the swipe is performed in a direction to move at least one of the fingers toward each other as pinch in. “Pinch out” is a gesture in which a swipe with a plurality of fingers is performed in a direction to move the fingers away from each other. The smartphone 1 may determine a gesture in which the swipe is performed in a direction to move at least one of the fingers away from each other as pinch out.

The smartphone 1 can perform some operations according to these gestures which are determined through the touch screen 2B. Because the operations are performed by the smartphone 1 based on the gestures, user-friendly and intuitive operability is achieved. The operations performed by the smartphone 1 according to the determined gestures may be different depending on the screen displayed on the touch screen display 2 at the time when the determined gesture is performed.

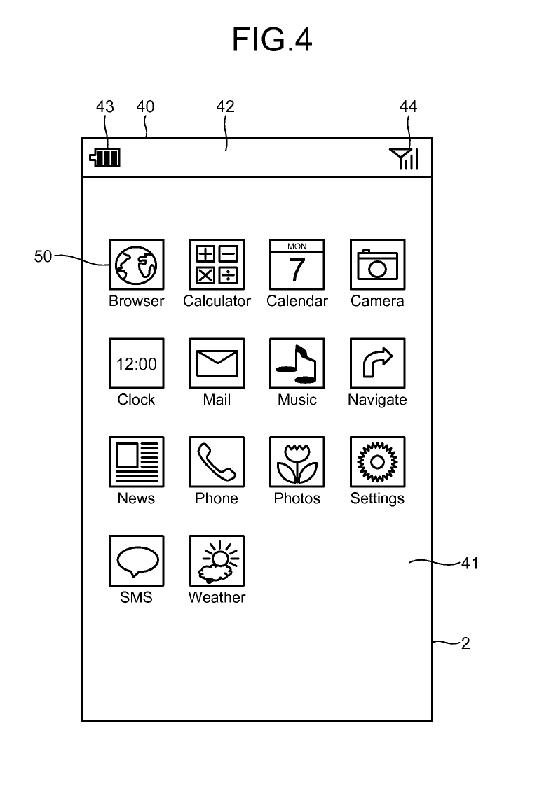

Some example of the screen displayed on the display 2A will be explained below with reference to FIG. 4. FIG. 4 represents some example of a home screen. The home screen may also be called “desktop”, “launcher”, or “idle screen”. The home screen is displayed on the display 2A. The home screen may be a screen allowing the user to select which one of applications installed in the smartphone 1 is executed. The smartphone 1 may execute the application selected on the home screen in the foreground. The display 2A may display the screen of the application executed in the foreground.

Icons may be positioned on the home screen of the smartphone 1. FIG. 4 is an example of a home screen 40. Icons 50 may be positioned on the home screen 40. Each of the icons 50 is previously associated with one of applications installed in the smartphone 1. When detecting a gesture for one of icons 50, the smartphone 1 can execute corresponding application(s) associated with a gestured icon. For example, when detecting a tap on an icon associated with a mail application, the smartphone 1 executes the mail application.

When detecting, for example, a click on the button 3B while executing the mail application in the foreground, the smartphone 1 may display the home screen 40 on the display 2A and execute the mail application in the background. When detecting a tap on one of the icons 50 associated with a browser application, the smartphone 1 can execute the browser application in the foreground. An application executed in the background can be interrupted or terminated according to an execution status of the application and of other application.

Each of the icons 50 may include an image and a character string. The icons 50 may contain a symbol or a graphic instead of an image. The icons 50 do not have to include either one of the image and the character string. The smartphone 1 may arrange the icons 50 according to a predetermined rule. The smartphone 1 may display a wall paper 41 behind the icons 50. The wall paper may sometimes be called “photo screen” or “back screen”. The smartphone 1 can use an arbitrary image as the wall paper 41. For the image, an arbitrary image is determined as the wall paper 41 according to, for example, setting of the user.

The smartphone 1 can increase or decrease the number of home screens. For example, the smartphone 1 may determine the number of home screens according to the setting of the user. The smartphone 1 can display a selected one of home screens on the display 2A even if the number of the home screens is plural.

The smartphone 1 can display one or more locators on the home screen. The number of symbols of the locator may coincide with the number of home screens. The symbol of a locator can represent a position of a currently displayed home screen. The smartphone 1 may display the symbol corresponding to the currently displayed home screen in a manner different from that of the other symbols.

When detecting a gesture while displaying the home screen, the smartphone 1 can change a current home screen, which is currently displayed, to another home screen on the display 2A. For example, when detecting a rightward flick, the smartphone 1 changes the current home screen to a home screen, which is positioned next one on the left side from the current home screen. Then, when detecting a leftward flick, the smartphone 1 can change the current home screen to a home screen, which is positioned next one on the right side from the current home screen. When the home screen is changed, the smartphone 1 may update the indication of the locator according to a current position of the current home screen after the change.

An area 42 is positioned on a top of the display 2A. The smartphone 1 can display a remaining mark 43 and a radio-wave level mark 44 on the area 42. The remaining mark 43 may indicate a remaining amount of a power supply. The radio-wave level mark 44 may indicate an electric field strength of radio wave for communication. The smartphone 1 may display current time, weather information, an application during execution thereof, a type of communication system, a status of a phone call, a mode of the device, an event occurring in the device, and the like in the area 42. The area 42 is used to inform the user of various notifications. The area 42 may be provided on any screen other than the home screen 40. A position, where the area 42 is provided, is not limited to the top of the display 2A.

A vertical direction of the home screen 40 will be explained herein. The vertical direction of the home screen 40 may be a direction based on a vertical, direction of a character or an image displayed on the display 2A. Therefore, in an example shown in FIG. 4, the side close to the area 42 in a longitudinal direction of the touch screen display 2 is the upper side of the home screen 40, and the side far from the area 42 is the lower side of the home screen 40. In the example shown in FIG. 4, the side where the radio-wave level mark 44 is displayed is the right side of the home screen 40, and the side in the area 42 where the remaining mark 43 is displayed is the left side of the home screen 40.

The home screen 40 illustrated in FIG. 4 is only some example, and therefore the configuration of each of elements, the arrangement of the elements, the number of home screens 40, the way to perform each of various operations on the home screen 40, and the like do not have to be like above mentioned explanations.

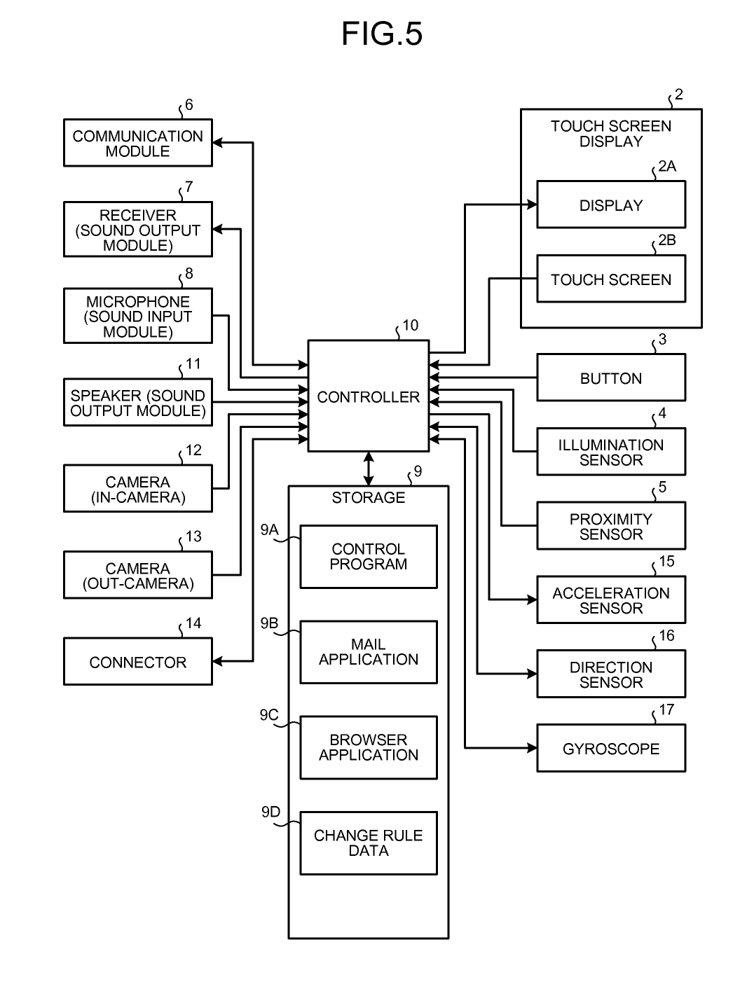

FIG. 5 is a block diagram of the smartphone 1. The smartphone 1 may include the touch screen display 2, the button 3, the illumination sensor 4, the proximity sensor 5, a communication module 6, the receiver 7, the microphone 8, a storage 9, a controller 10, the cameras 12 and 13, the connector 14, an acceleration sensor 15, a direction sensor 16, and a gyroscope 17.

The touch screen display 2 includes, as explained above, the display 2A and the touch screen 2B. The display 2A can display text, images, symbols, graphics, or the like. The touch screen 2B can accept a contact to an acceptance area as input. In other words, the touch screen 2B can detect a contact. The controller 10 can detect a gesture performed on the smartphone 1. The controller 10 can detect an operation (via a gesture) for the touch screen 2B (may be or the touch screen display 2) in cooperation with the touch screen 2B.

The user can operate the button 3. The button 3 may include a buttons 3A to 3F. The controller 10 can detect an operation for one of the buttons 3A to 3F in cooperation with the buttons 3A to 3F. Examples of the operations for one of the buttons 3A to 3F may include, but are not limited to, a click, a double click, a push, a long push, and a multi-push.

For example, the buttons 3A to 3C may be a home button, a back button, or a menu button. In some embodiment, a touch sensor type button is adopted as the buttons 3A to 3C. For example, the button 3D may be a power on/off button of the smartphone 1. The button 3D may function also as a sleep/sleep release button. For example, the buttons 3E and 3F may be volume buttons.

The illumination sensor 4 can detect illumination. For example, the illumination may indicate intensity of light, lightness, or brightness. The illumination sensor 4 is used, for example, to adjust the brightness of the display 2A. The proximity sensor 5 can detect a presence of a nearby object without any physical contact. The proximity sensor 5 can detect that, for example, the touch screen display 2 is brought close to User's face and the like.

The communication module 6 can communicate by wireless communication. A communication method performed by the communication module 6 may include a wireless communication standard. The wireless communication standard may include, for example, a cellular-phone communication standard such as 2G, 3G, and 4G. The cellular-phone communication standard may include, for example, LTE (Long Term Evolution), W-CDMA (Wideband Code Division Multiple Access), CDMA 2000, PDC (Personal Digital Cellular), GSM (registered trademark) (Global System for Mobile Communications), and PHS (Personal Handy-phone System). The wireless communication standard may include, for example, WiMAX (Worldwide Interoperability for Microwave Access), IEEE 802.11, Bluetooth (registered trademark), IrDA (Infrared Data Association), and NFC (Near Field Communication). The communication module 6 may support one or more of the communication standards.

The receiver 7 and the speaker 11 may be one of some sound output modules. The receiver 7 and the speaker 11 can output a sound signal transmitted from the controller 10 as sound. The receiver 7 may be used, for example, to output the other party's voice during a call. The speaker 11 may be used, for example, to output a ring tone and music. One of the receiver 7 and the speaker 11 may double as the other function. The microphone 8 may be one of some sound input modules. The microphone 8 can convert the voice of the user or the like to a sound signal and transmits a converted sound signal to the controller 10.

The storage 9 can store some programs and some data. The storage 9 may be used also as a work area that temporarily stores a processing result of the controller 10. The storage 9 may include any storage device such as a semiconductor storage device and a magnetic storage device. The storage 9 may include a plurality of types of storage devices. The storage 9 may include a combination of a portable storage medium such as a memory card with a reader of the storage medium.

Programs stored in the storage 9 include applications executed in the foreground or the background and a control program for assisting operations of the applications. The application causes the controller 10, for example, to display a predetermined screen on the display 2A and perform processing according to a gesture detected through the touch screen 2B. The control program is, for example, an OS. The applications and the control program may be installed in the storage 9 through wireless communication by the communication module 6 or through a storage medium.

The storage 9 can store, for example, a control program 9A, a mail application 9B, a browser application 9C, and change rule data 9D. The mail application 9B may provide an e-mail function for composing, transmitting, receiving, and displaying an e-mail, and the like. The browser application 9C may provide a WEB browsing function for displaying WEB pages.

The control program 9A may provide a function related to various controls for operating the smartphone 1. The control program 9A may control, for example, the communication module 6, the receiver 7, and the microphone 8 to make a phone call. The functions provided by the control program 9A can be used in combination with a function provided by the other program such as the mail application 9B.

The function provided by the control program 9A includes, for example, a function of stopping an operation according to a gesture based on a change rule of the change rule data 9D. The change rule data 9D is data for storing a gesture to stop or to invalidate the operation according to the performed gesture, among gestures performed on the screen displayed on the display.

The controller 10 may include, for example, a CPU (Central Processing Unit). The controller 10 may be an integrated circuit such as SoC (System-on-a-chip). One or more other components such as the communication module 6 and like may be integrated in the integrated circuit. The controller 10 may include one or more driver ICs (Integrated Circuits) of other components such as the touch screen 2B and like. The controller 10 integrally controls the operations of the smartphone 1 to implement various functions.

The controller 10 can execute instructions contained in the program stored in the storage 9 while referring to the data stored in the storage 9 as necessary, and control the display 2A and the communication module 6, etc. to thereby implement the various functions. The controller 10 can change the control according to the detection result of each of various detectors such as the touch screen 2B, the button 3, and the acceleration sensor 15.

The camera 12 may be called as an in-camera for photographing an object facing the front face 1A. The camera 13 may be called as an out-camera for photographing an object facing the back face 1B.

The connector 14 may be a terminal to which other device is connected. The connector 14 may be a general-purpose terminal such as a USB (Universal Serial Bus), an HDMI (registered trademark) (High-Definition Multimedia Interface), Light Peak (Thunderbolt), and an earphone/microphone connector. The connector 14 may be a dedicated terminal such as a dock connector. Examples of the devices connected to the connector 14 include, but are not limited to, a charger, an external storage, a speaker, a communication device, and an information processor.

The acceleration sensor 15 can detect a direction and a magnitude of acceleration applied to the smartphone 1. The direction sensor 16 can detect a direction of geomagnetism. The gyroscope 17 can detect an angle and an angular velocity of the smartphone 1. The detection results of the acceleration sensor 15, the direction sensor 16, and the gyroscope 17 may be used in combination with each other in order to detect a position of the smartphone 1 and a change of its attitude.

Part or all of the programs stored in the storage 9 in FIG. 5 may be downloaded from any other device through wireless communication by the communication module 6. Part or all of the programs stored in the storage 9 in FIG. 5 may be stored in a storage medium that can be read by the reader included in the storage 9. Part or all of the programs stored in the storage 9 in FIG. 5 may be stored in a storage medium such as CD, DVD, or Blu-ray (registered trademark) that can be read by a reader connected to the connector 14.

The configuration of the smartphone 1 illustrated in FIG. 5 is only an example, and therefore it can be modified as required within a scope that does not depart from the gist of the present disclosure. For example, the number and the type of the button 3 are not limited to an example of FIG. 5. For example, the smartphone 1 may be provided with buttons of a numeric keypad layout or a QWERTY layout and so on as buttons for operations of the screen instead of the buttons 3A to 3C. The smartphone 1 may be provided with only one button to operate the screen, or with no button. In some example illustrated in FIG. 5, the smartphone 1 is provided with two cameras; however, the smartphone 1 may be provided with only one camera or with no camera. The illumination sensor 4 and the proximity sensor 5 may be configured with one sensor. In some example of FIG. 5, the smartphone 1 is provided with three types of sensors in order co detect its position and attitude; however, the smartphone 1 does not have to be provided with some of the sensors, or may be provided with any other type of sensor for detecting the position and the attitude.

Some example in which the smartphone 1 may perform a control based on a gesture input of the user to the touch screen display 2 will be represented below.

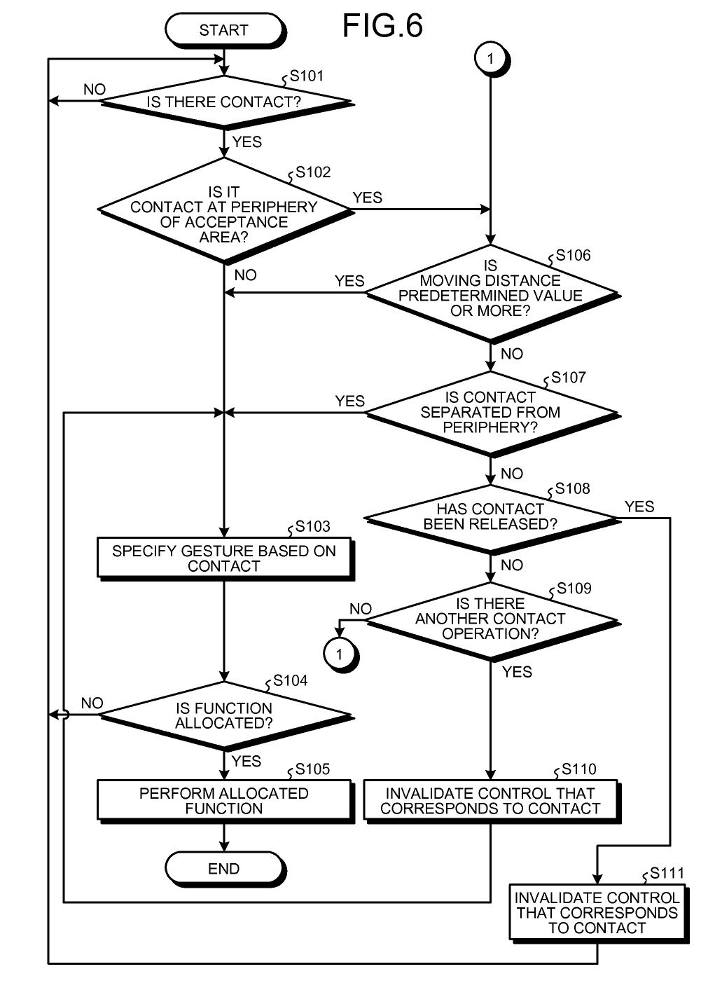

FIG. 6 is a diagram of an example of a control flow performed by the smartphone according to some embodiment. In the control flow illustrated in FIG. 6, the change rule data 9D may be used for the control flow in the program. The smartphone can repeatedly perform the control flow illustrated in FIG. 6. As illustrated at Step S101, the smartphone 1 detects the presence or absence of a contact with the touch screen 2B. When a contact with the touch screen 2B has not been detected (No at Step S101), the smartphone 1 repeats Step S101 until the contact is detected.

When a contact with the touch screen 2B has been detected (Yes at Step S101), as illustrated at Step S102, the smartphone 1 determines whether the contact position is in a periphery of the acceptance area of the touch screen 2B. This determination is performed by the controller 10 based on position information of the contact. The position information is transmitted to the controller 10 when the touch screen 2B detects the contact. In some embodiment, depending on whether the contact position is in a periphery of the acceptance area of the touch screen 2B, the subsequent flow is changed.

At Step S102, when the contact is made to the center of the acceptance area of the touch screen 2B, the smartphone 1 determines that the contact position is not in the periphery of the acceptance area of the touch screen 2B (No at Step S102), and proceeds to Step S103. At this time, the smartphone 1 determines that the input due to the contact is a normal touch gesture at Step S103 and subsequent steps, and performs the subsequent control. At Step S103, the smartphone 1 specifies a gesture based on the contact. When the gesture is specified, the smartphone 1 proceeds to Step S104. At Step S104, the smartphone 1 determines whether any function is allocated to the specified gesture on the displayed screen. When the function is allocated thereto (Yes at Step S104), the smartphone 1 proceeds to Step S105, and performs the allocated function. Subsequently, the process ends. When any function is not allocated (No at Step S104), the smartphone 1 returns to Step S101.

When it is determined that the contact position is in a periphery of the acceptance area of the touch screen 2B at Step S102 (Yes at Step S102), the smartphone 1 proceeds to Step S106. At Step S106 and subsequent steps, the smartphone 1 determines that the input due to the contact is likely to be an incorrect contact, and performs the subsequent control. Herein, the input obtained by touching on the periphery of the acceptance area will be explained as a first input. At Step S106, the smartphone 1 determines whether a moving distance of the first input is a predetermined value or more. This determination is performed by the controller 10 based on the change in the contact position of the detected first input. The change of the position information is transmitted from the touch screen 2B to the controller 10. When the moving distance of the contact position is a predetermined value or more (Yes at Step S106), the smartphone 1 determines that the first input is the normal touch gesture, and proceeds to Step S103. When the moving distance is smaller than the predetermined value (No at Step S106), the smartphone 1 determines that the first input is likely to be an incorrect contact, and proceeds to Step S107. By determining whether the moving distance after the touch is the predetermined value or more, the smartphone 1 can discriminate between the touch gesture such as a swipe and the incorrect contact.

At Step S107, the smartphone 1 determines whether the contact position of the first input is separated from the edge. This determination is performed by the controller 10 based on the distance of the detected contact position of the first input from the edge of the acceptance area or based on the coordinates of the contact position. The change of the position information is transmitted from the touch screen 2B to the controller 10. When the contact position of the first input is separated from the periphery (Yes at Step S107), the smartphone 1 determines that the first input is the normal touch gesture, and proceeds to Step S103. When the contact position of the first input remains in the periphery without being separated from the periphery (No at Step S107), the smartphone 1 determines that the first input is likely to be an incorrect contact, and proceeds to Step S108. By determining whether the moving distance after the touch is the predetermined value or more, the smartphone 1 can discriminate between the touch gesture such as a swipe and the incorrect contact.

At Step S108, the smartphone 1 determines whether contact (i.e., a first input) is released. If the first input is released (Yes at Step S108), the process proceeds to Step 111 so that control of function corresponding to the contact is invalidated. Subsequently, the process returns to step S101. In case of proceeding from step 108 to step 111, as control corresponding to the first input not being performed, it can be deemed that the first input has not existed. If the first input is not released (No at step S108), the process proceeds to step 109.

At Step S109, the smartphone 1 determines the presence or absence of another contact operation during the contact of the first input. In other words, the smartphone 1 determines the presence or absence of another effective contact which is determined as not the incorrect contact during the contact of the first input. When it is determined that there is another effective contact at Step S109 (Yes at Step S109), the smartphone 1 determines that the first input is the incorrect contact, and proceeds to Step S110. The presence or absence of another effective contact will be explained in detail later. When it is determined that there is no another effective contact (No at Step S109), the process returns to step S106.

At Step S110, control of function corresponding to the contact is invalidated as the first input is incorrect. Subsequently, the process proceeds to step S103. If the process proceeds from Step S108 to Step S111, the smartphone 1 can skip a determination about the first input despite having detected the first input. As a result, the amount of information can be reduced.

Here, the presence or absence of another effective contact at Step S109 will be explained in detail. The step S109 can include steps, for example, similar to step S102, step S106 and step S107. The step S109 may include only one step similar to step S102. The step S109 may include steps similar to step S102 and either step S106 or step S107. At step S109, it is determined whether another contact is effective, in other words, another contact is valuable for identifying gesture. Description of the above mentioned respective steps is omitted.

In the control flow according to some embodiment, Steps S106 to S109 are repeated until the process proceeds to Step S103, or S110 or S111. That is, in the control flow, the control is performed based on the determination of the input due to the contact as effective, or the control based on the first input is suspended without being performed until the control is invalidated based on the determination of the input as the incorrect contact. In other words, in the control flow according to some embodiment, the control is suspended without being performed or the control is invalidated until it is determined that the input due to the contact is effective. Therefore, in the control flow according to some embodiment, it is possible to reduce the consideration of the user against the incorrect contact and improve the operability of the touch screen display 2.

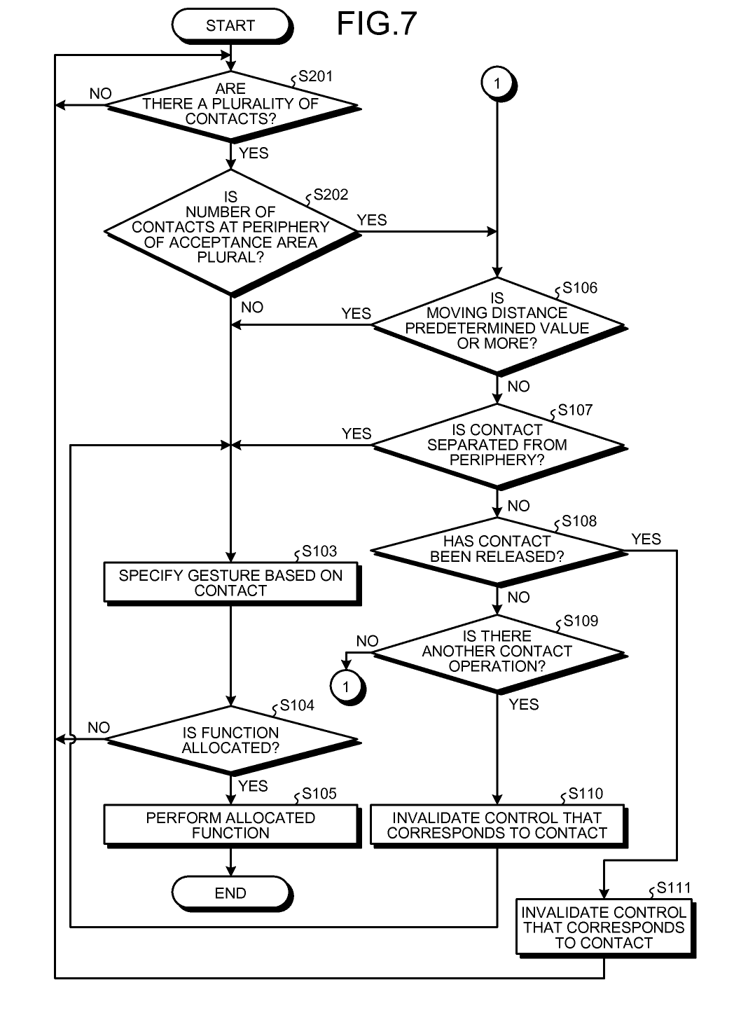

FIG. 7 is a diagram of another example of a control flow performed by the smartphone 1 according to some embodiment. In the control flow illustrated in FIG. 7, the change rule data 9D may be used for control flow in the program. The control flow is different from above example in a point that Steps S201 and S202 are provided instead of Steps S101 and S102, but the other steps are common. Hereinafter, the explanation overlapping some embodiment is omitted and only the flow of different operation is described.

When detecting a plurality of contacts on the touch screen 2B at Step S201, the smartphone 1 proceeds to Step S202. At Step S202, the smartphone 1 determines whether there is a plurality of contacts to the periphery of the acceleration area of the touch screen 2B. This determination is performed by the controller 10 based on respective pieces of position information of the contacts. The pieces of position information are transmitted to the controller 10 when the touch screen 2B detects the contacts. When it is determined that the number of contacts to the a periphery of the acceleration area is not plural (No at Step S202), the smartphone 1 proceeds to Step S103, while when it is determined that the number of contacts to the a periphery of the acceleration area is plural (Yes at Step S202), the smartphone 1 proceeds to Step S106.

Although the present disclosure has been described with respect to some embodiments for a complete and clear disclosure, the appended claims are not to be thus limited but are to be construed as embodying all modifications and alternative constructions that may occur to one skilled in the art which fairly fall within the basic teaching herein set forth.

At Step S202 in the control flow illustrated in FIG. 7, by having a relationship between contact positions of the contacts, it is possible to further improve the operability. For example, when the touch screen 2B is rectangular, it may be configured, as a relationship between the contact positions of the contacts, to add a condition such as one a periphery along one of the sides of the touch screen 2B and two paired peripheries in the touch screen 2B. By adding such a detailed condition, it is possible to accurately determine an incorrect contact by considering whether the user operates the smartphone 1 with both hands or with one hand.

At Step S102 or S202 in the control flows illustrated in FIGS. 6 and 7, a periphery of an acceptance area, of peripheries of the acceptance area, becoming a condition that proceeds to Step S106 may be specified. For example, when the touch screen 2B is rectangular, it may be configured to change the a periphery of the acceptance area becoming a condition for determining that there is a possibility of an incorrect contact, according to whether the orientation of the screen is portrait or landscape.

In the control flows illustrated in FIGS. 6 and 7, as a condition for determining that there is a possibility of an incorrect contact, it is based on the contact to the a periphery of the acceptance area; however, it may be based on whether the contact position includes the a periphery of the acceptance area. In this way, the condition is based on the contact to the a periphery of the acceptance area, which enables to more accurately determine the incorrect contact in the case of, for example, holding the smartphone 1. In this case, it is possible to more accurately determine whether the contact is an incorrect contact or an intentional operation based on the decision at Step S107.

The order of Step S106, Step S107, and Step S108 in the control flows illustrated in FIGS. 6 and 7 may be interchanged. Any one of Step S106, Step S107, and Step S108 may be omitted. The number of steps to be omitted may be one, two, or even three.

In some embodiments, the smartphone 1 has been explained as some example of the mobile device with the touch screen display; however, the mobile device according to the appended claims is not limited to the smartphone 1. For example, the mobile device according to the appended claims may be a mobile electronic device such as a mobile phone, a mobile personal computer, a digital camera, a media player, an electronic book reader, a navigator, or a gaming device. The device according to the appended claims may be a stationary-type electronic device such as a desktop personal computer and a television receiver.

What is claimed is:

1. A mobile device comprising:
a touch screen display including an acceptance area to accept a touch; and
a controller configured to control function of the mobile device on the basis of the touch, wherein
when the touch includes at least one first touch at periphery of the acceptance area, the controller is configured to suspend function of the mobile device corresponding to the at least one first touch.

2. The mobile device according to claim 1,
wherein
when the controller detects another touch while suspending, the controller is configured to invalidate function of the mobile device corresponding to the first touch.

3. The mobile device according to claim 1,
wherein,
When a moving distance of the first touch is greater than a predetermined value, the controller is configured to control the mobile device on the basis of the first touch.

4. The mobile device according to claim 1,
wherein,
when a distance between a position of the first touch and an edge of the acceptance area is greater than a predetermined value, the controller is configured to control the mobile device on the basis of the first input.

5. The mobile device according to claim 1,
Wherein
the periphery of the acceptance area includes an edge of the acceptance area.

6. The mobile device according to claim 2,
Wherein
the other touch includes a moving touch.

7. A method of controlling a mobile device, which includes: a touch screen display including an acceptance area to accept a touch; and a controller configured to control function of the mobile device on the basis of the touch, the method comprising the steps of:
accepting the touch in the acceptance area; and
suspending, by the controller, function of the mobile device corresponding to at least one first touch, if the touch includes the at least one first touch at periphery of the acceptance area.

8. A computer program product having computer instructions, stored on a non-transitory computer readable storage medium, for enabling a computer of a mobile device, which includes: a touch screen display including an acceptance area to accept a touch; and a controller configured to control function of the mobile device on the basis of the touch, executing the computer instructions to perform operations comprising:
accepting the touch in the acceptance area; and
suspending function of the mobile device corresponding to at least one first touch, if the touch includes the at least one first touch at periphery of the acceptance area.
